(19) United States
(12) Patent Application Publication
(10) Pub. No.: US 2006/0179884 A1
(43) Pub. Date: Aug. 17, 2006

(54) Glassware forming machine mold cooling apparatus and method

(76) Inventors: Frank J. DiFrank, Toledo, OH (US); D. Wayne Leidy, Toledo, OH (US); Thomas R. Kirkman, Perrysburg, OH (US)

Correspondence Address: OWENS-ILLINOIS, INC., ONE SEAGATE, 25-LDP, TOLEDO, OH, 43666, US

(21) Appl. No.: 10/738,103

(22) Filed: Dec. 17, 2003

(51) Int. Cl. C03B 11/12; C03B 9/38

(52) U.S. Cl. 65/85; 65/356

(57) ABSTRACT

In a blank mold side of an I.S. glass container forming machine, mold cooling air flows from a fixed source through a supply conduit to a plenum that underlies and oscillates with a mold-carrying arm. Cooling air from the source flows upwardly through the supply conduit and then into a hollow member that has an inlet portion telescopically received in an outlet of the supply conduit. The hollow member, which is capable of oscillating motion in a horizontal plane with respect to the supply conduit, has a horizontally-facing outlet with an annular part-spherical bearing surface, and an annular part-spherical bearing is positioned in the part-spherical bearing surface for pivoting motion in a vertical plane of the part-spherical bearing with respect to the hollow member. A cooling air inlet tube has an inlet end telescopically received in the part-spherical bearing. The outlet end of the cooling air inlet tube is non-telescopically received in a part-spherical bearing surface of the plenum. In a blow mold side of an I.S. glass container forming machine, cooling air flows from a fixed source through a supply conduit to a plenum that underlies and oscillates with a mold-carrying arm without any substantial change in the direction of air flow therethrough. A cooling air inlet tube having an outer element, an inner element telescopically positioned within the outer element and a spring to resiliently bias the inner element and the outer element away from one another is provided to accommodate changes in distance between the source and the plenum that occur because of oscillating motion of the mold-carrying arm.

### FIELD OF THE INVENTION

This invention relates to a glassware forming machine of the individual section (I.S.) type in which one or more mold halves carried by each of an opposed pair of mold carrying arms are periodically oscillated into and out of closed positions to form closed molds. More particularly, this invention relates to the distribution of cooling air to the mold carrying arms to cool the mold halves, notwithstanding the movement of the mold halves relative to a source of cooling air due to the oscillating motion of the mold-carrying arms and the variation in the lengths of the cooling air flow paths that results therefrom.

### BACKGROUND OF THE INVENTION

U.S. Pat. No. 4,909,823 (Bollin) and U.S. Pat. No. 5,304,229 (Swanfeld) relate to the distribution of cooling air from a windbox of an I.S. machine to opposed sets of mold halves. The mold halves are carried by opposed arms that are repeatedly oscillated or swung into and out of closed positions in which opposed mold halves are joined to form article-forming molds. As is clear from these references, the motions of the mold carrying arms require that the conduits for introducing cooling air from the windboxes to the mold carrying arms be capable of expanding and contracting in length and in pivoting relative to the source during operation, because of the movement of the mold carrying arms relative to the windboxes. The '823 patent teaches the use of a pivoting slide member to connect the inlet of an associated air flow conduit to an associated mold carrying arm, with a bushing telescoped partly into an outlet of the air flow conduit and partly into a plenum carried by the associated mold carrying arm, to permit relative turning motion between the air flow conduit and the mold carrying arm plenum. Of course, the bushing that is partly telescoped into the outlet of the air flow conduit decreases its diameter at that location, and thereby serves as a cooling air flow obstruction to reduce the flow of cooling air to the molds for a given air pressure source. Further, the use of a slide member at the inlet of the airflow conduit, which serves to accommodate spacing changes between the plenum to which inlet is attached and the mold carrying arm plenum to which its outlet is connected due to the oscillating motion of the mold carrying arm, is subject to maintenance problems in the hostile, high temperature environment of an I.S. glass containing forming machine.

A slide of the type taught by the '823 patent was eliminated in the '229 patent by connecting the inlet of the cooling air tube to its source by a part-spherical bearing capable of pivoting motion both in a horizontal plane and in a vertical plane, in the orientation depicted in FIG. 2 of the reference. Similarly, The cooling air tube outlet is connected to the mold carrying arm plenum by a part-spherical bearing, to thereby permit swinging motion of the cooling air tube outlet relative to the plenum to which its inlet is connected. The variation in length of the cooling air tube caused by the swinging motion of the mold carrying arm, which was accommodated in the '823 patent by the slide connection between the cooling air tube inlet and the source plenum, is provided in the '229 patent by a telescopic connection between the cooling air tube and the part-spherical bearing in which its inlet is received. However, the cooling air tube taught by the reference varies in wall thickness from a greater thickness at its outlet to a lesser thickness at its inlet, which requires a special and more expensive manufacturing technique and limits the available cross-sectional flow area in the thicker portion of the air flow tube and thereby reduces the rate of air flow through the tube for a given source pressure.

### BRIEF DESCRIPTION OF THE INVENTION

According to the present invention, there is provided an arrangement for delivering cool air from a fixed source, such as a windbox of a glass container forming machine of the I.S. type, to a movable object, such as a pivotable mold-carrying arm of the I.S. machine, and of doing so without unnecessary impediments to the flow of cooling air and in the inhospitable, high temperature environment of a glass container forming machine. The arrangement of this invention uses, for each mold-carrying pivoting arm, a single air flow tube of uniform wall thickness at least one of whose opposed ends is received in a part-spherical bearing to permit the tube to swivel both with respect to the source of cooling air to which its inlet end is connected, and to a receiver for cooling air to which its outlet end is connected. One of the inlet and outlet ends of the cooling air tube, preferably the inlet end because it is in a cooler environment, is telescopically mounted in the part-spherical bearing in which it is received to permit accommodation of changes in distance or spacing between the part-spherical bearing at the inlet of the cooling air tube and the part-spherical bearing at its outlet, as the outlet oscillates in service relative to the inlet. The part-spherical bearing at the inlet to the oscillating cooling air tube is mounted in a hollow member that is telescoped into a vertical conduit from a windbox of the I.S. machine, rather than into the vertical conduit itself, and the hollow member has a horizontally-facing outlet that caries the part-spherical inlet bearing for a better and smoother inlet angle into the oscillating cooling air inlet tube. The invention is adaptable both to the cooling of blank molding molds at a blank molding side of an individual section (I.S.) glass container forming machine, where preforms or parisons of containers are formed from gobs of glass at an elevated, formable temperature, and to the cooling of blow molds at a blow molding side of an I.S. machine, where containers are blown from parisons after the transfer of parisons from the blank molds to the blow molds.

Accordingly, it is an object of the present invention to provide an improved apparatus and method for distributing cooling air from a first location to a second location in which one of the first location and the second location is fixed, and the other of the first location and the second location oscillates relative to the fixed location. More particularly, it is the object of the present invention to provide an apparatus and method of the aforesaid character in which the fixed location is a windbox of a glass container forming machine and the outlet is a plenum carried by an oscillating, mold-carrying arm of the forming machine.

For a further understanding of the present invention and the objects thereof, attention is directed to the drawing and the following brief description thereof, to the detailed description of the invention and to the appended claims.

### BRIEF DESCRIPTION OF THE DRAWINGS

FIG. 1 is a fragmentary perspective view of a portion of an I.S. machine that incorporates parison-molding apparatus according to a preferred embodiment of the present invention;

FIG. 2 is a plan view of the apparatus of FIG. 1;

FIG. 3 is a fragmentary elevation view, partly in cross-section, of a portion of the apparatus of FIGS. 1 and 2;

FIG. 4 is a view like FIG. 1 of a portion of an I.S. machine that incorporates container blow molding apparatus according to a preferred embodiment of the present invention;

FIG. 5 is a plan view of the apparatus of FIG. 4;

FIG. 6 is an elevation view taken in the direction of the arrow 6 in FIG. 5; and

FIG. 7 is a sectional view, at an enlarged scale, taken on line 7-7 in FIG. 6.

### DETAILED DESCRIPTION OF THE INVENTION

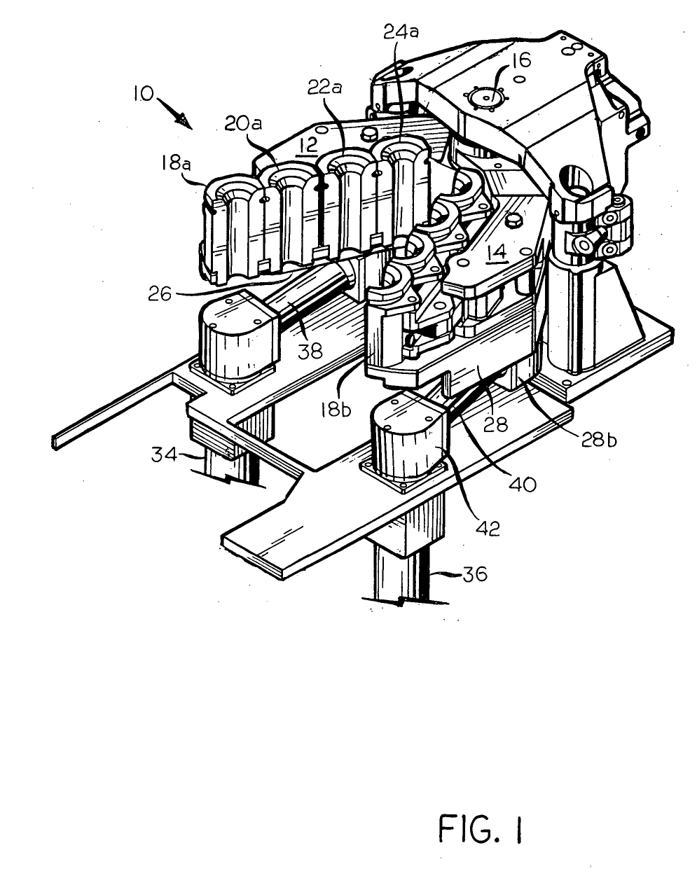

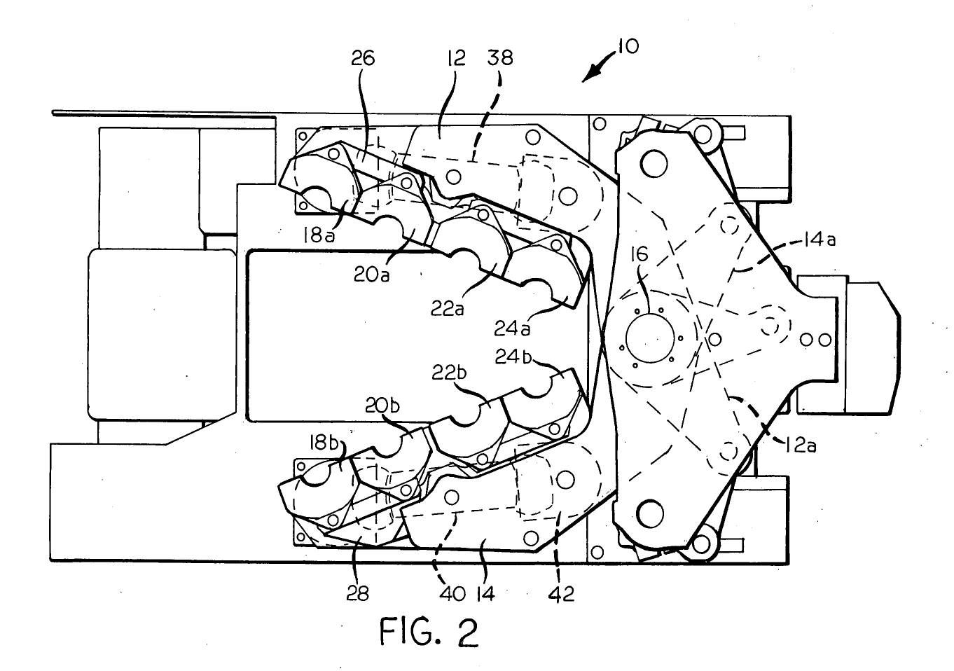

Apparatus according to an embodiment of the present invention is indicated generally by reference numeral 10 in FIGS. 1 and 2. The apparatus 10, which may be considered to be a portion of a glass container forming machine of the I.S. type at a blank side of the machine, is made up of-an opposed pair of mold carrying arms 12, 14 that are mounted for pivoting movement about a vertical shaft 16. The mold-carrying arms 12, 14 carry mold halves of one or more glass article forming molds, shown as four such mold halves 18a, 20a, 22a, 24a that are carried by the arm 12, and the mold halves 18b, 20b, 22b, 24b that are carried by the arm 14. The mold arms 12, 14 are caused to counter-oscillate about the shaft 16 by forces applied to their opposed ends 12a, 14a, respectively, for example, in the manner taught by U.S. Pat. No. 4,427,431 (Mumford et al.) or by U.S. Pat. No. 3,472,639 (Mumford), the disclosure of each of which is incorporated by reference herein, or as taught, for example, in commonly-assigned U.S. Pat. No. 6,557,380 B1 (DiFrank et al.), the disclosure of which is also incorporated by reference herein. In any case, the counter-oscillating motion of the arms 12, 14 is effective to oscillate the arms 12, 14 between mold-open positions, shown in FIGS. 1 and 2, and mold-closed positions, not shown, where mold halves 18a, 18b are joined to form a closed mold; likewise, mold halves 20a, 20b; 22a, 22b; and 24a, 24b form closed molds in the mold-closed positions of the arms 12, 14. Each of the mold-carrying arms 12, 14 is provided with a plenum 26, 28, respectively, for receipt of cooling air, as hereinafter described, and for flow therefrom to the mold halves carried by such mold arm in a manner known in the art, to aid in cooling the mold halves and hot glass articles in enclosed molds defined by the opposed mold halves. The plenums 26, 28 receive cooling air from windboxes (not shown), which are fixed in the apparatus 10, by way of fixed vertical conduits 34, 36, respectively, and cooling air is delivered to the plenums 26, 28 from the conduits 34, 36, respectively, through inlet tubes 38, 40, respectively.

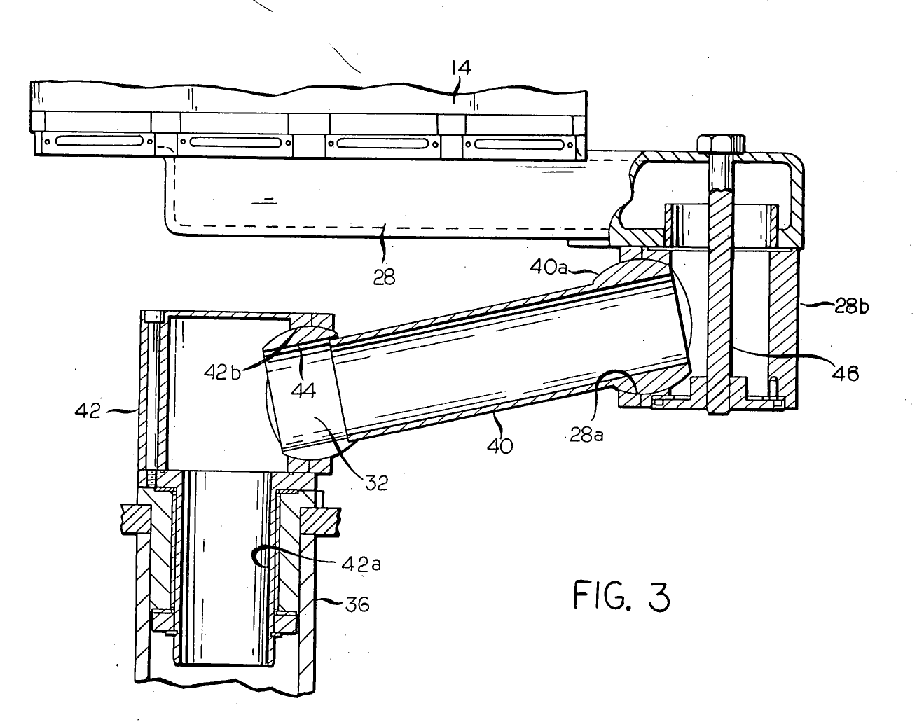

FIG. 3 illustrates the construction setting forth the air flow path from the windbox through the conduit 36 and the air inlet tube 40 to the plenum 28 that is carried by the mold arm 14. It is to be understood that the cooling air flow path from the windbox for the plenum 26 that is carried by the mold arm 12 is but an opposite-hand version of that from the windbox to the plenum 28. A generally T-shaped hollow member 42 is positioned at the upper end of the conduit 36, and the member 42 has an annular shank portion 42a that extends down into an upper portion of the conduit 36 to permit cooling air to flow from the conduit 36 into the hollow member 42. The hollow member 42 is mounted for limited oscillating movement in a horizontal plane relative to the conduit 36, and is provided with an annular, part-spherical bearing surface 42b that has an horizontally-facing outlet therefrom. The bearing surface 42b has an annular bearing 44 with a part-spherical outer surface mounted therein for pivoting motion of the bearing 44 relative to the hollow member 42 in a vertical plane, the bearing 44 being pinned at 32 to limit its pivoting motion to motion only in a vertical plane. The bearing 44 has an inlet end of the air inlet tube 40 slidingly positioned in its inner surface for telescopic motion of the inlet tube 40 relative to the bearing 44. The inlet tube 40 has a part-spherical bearing portion 40a at its outlet end, and is of uniform wall thickness from its inlet end to the beginning of its bearing portion 40a. This permits a maximum inside diameter of the air inlet tube 40 for a given wall thickness of the air inlet tube 40, and this maximizes the rate of cooling air flow through the air inlet tube 40 for a given source pressure at its inlet end.

The part-spherical bearing surface 40a of the air inlet tube 40 is received in a part-spherical bearing 28a of a hollow, depending portion 28b of the plenum 28. The depending portion 28b is removably secured to an overlying portion of the plenum 28 by a bolt 46. Because of the presence of the bolt 46, and because the temperature is higher at the plenum 28 than it is at the hollow member 42, it is preferred that telescopic motion between the air inlet tube 40 at one of the bearings at its ends be at its inlet end, namely, between the air inlet tube 40 and the bearing 44. In any case, motion of the plenum 28 with the mold carrying arm 14 relative to the conduit 36, as heretofore described, will permit the air inlet tube 40 to swivel in a vertical plane relative to the conduit 36 by virtue of the part-spherical contact between the bearing 44 and the bearing surface 42b, and will also permit the air inlet tube 40 to swivel, both in a vertical plane and in a horizontal plane, relative to the depending portion 28b of the plenum 28 by virtue of the part-spherical contact between the bearing portion 40a of the air inlet tube 40, and the depending portion 28b of the plenum 28. Such motion will change the angular orientation of the air inlet tube 40; it will also change the spacing between the bearing 44 and the depending portion 28b, and such change in spacing will be accommodated by reversing linear plunging motion between the air inlet tube 40 and the bearing 44.

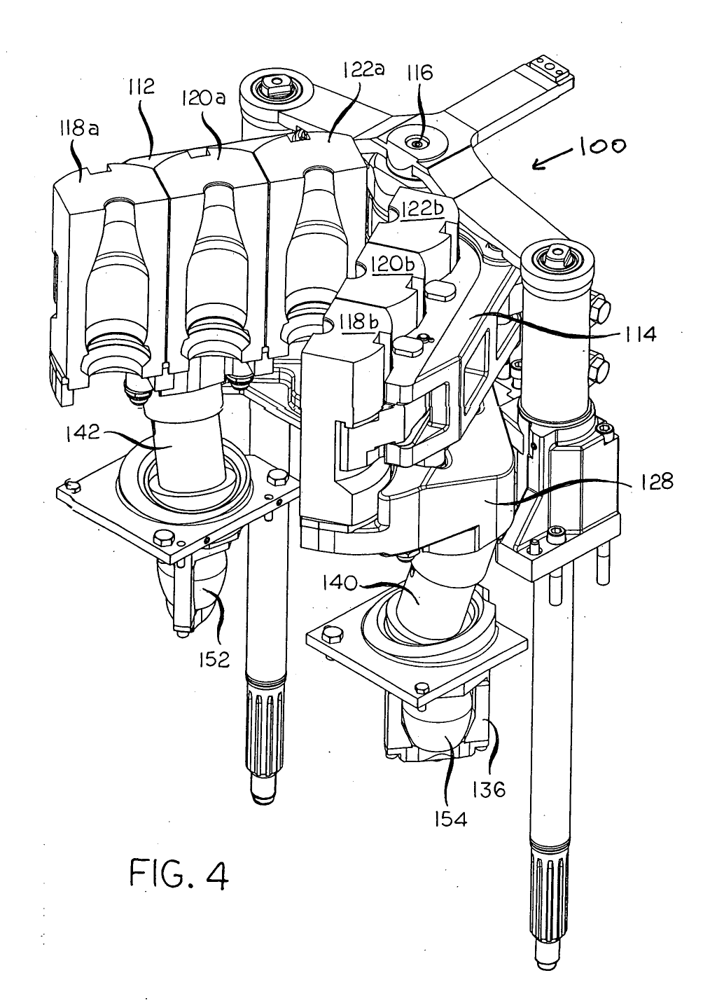

Apparatus according to another embodiment of the present invention is generally indicated by reference numeral 100 in FIG. 4. The apparatus 100, which may be considered to be a portion of a glass container forming machine of the I.S. type at a blow mold side of the machine, is made up of an opposed pair of mold carrying arms 112, 114 that are mounted for pivoting movement about a vertical shaft 116. The mold carrying arms 112, 114 carry mold halves of one or more glass articles forming mold, shown as three such mold halves 118a, 120a, 122a that are carried by the arm 112, and mold halves 118b, 120b, 122b that are carried by the arm 114. The mold arms 112, 114 are caused to counter-oscillate about the shaft 116 by forces applied to their opposed ends (not shown), for example, in the manner taught by the aforesaid U.S. Pat. No. 4,427,431 or by the aforesaid U.S. Pat. No. 3,472,639 or by the aforesaid U.S. Pat. No. 6,557,380 B1. In any case, the counter-oscillating motion of the arms 112, 114 is effective to oscillate the arms 112, 114 between mold-open positions, shown in FIG. 4, and mold-closed positions, not shown, where mold halves 118a, 118b are joined to form a closed-mold; likewise, mold halves 120a, 120b; and 122a, 122b form closed molds in the mold-closed positions of the arms 112, 114. It is to be noted that the apparatus 100 is adapted for forming containers by the triple gob process in which three containers are simultaneously formed in each section of an I.S. machine, whereas apparatus 10 is suited for simultaneously forming four containers at each section of an I.S. machine, according to the so-called “quad” process. Of course, the apparatus 10 can also be adapted to forming containers by a triple gob process, or even by a double gob process or a single gob process; likewise, the apparatus 110 can be adapted to forming containers by a quad process, or even by a double gob or single gob process.

Each of the mold carrying arms 112, 114 is provided with a plenum 126, 128, respectively, for receipt of cooling air as hereinafter described, and for flow therefrom to the mold halves carried by such mold arms in a manner known in the art, to aid in cooling the mold halves and hot glass articles in enclosed molds defined by the opposed mold halves. The plenums 126, 128 receive cooling air from windboxes (not shown), which are fixed in the apparatus 100, by way of fixed vertical conduits of 134, 136, respectively, and cooling air is delivered to the plenums 126, 128 from the conduits 134, 136, respectively, through an inlet tube 140 that leads to the plenum 128 and a like inlet tube 142 that leads to the plenum 126. The rate of air flow through the conduits 134, 136 is controlled on an on/off basis by conventional, externally controlled egg (axial flow) valves 152, 154, respectively, in the conduits 134, 136.

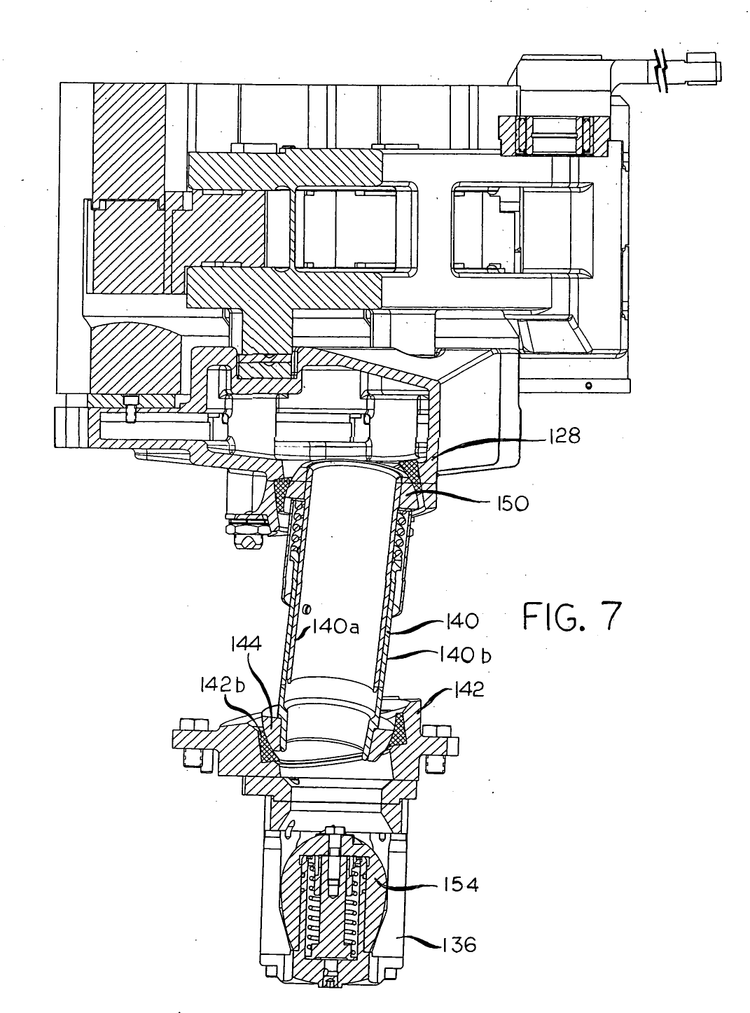

FIG. 7 illustrates the construction setting forth the air flow path from the windbox through the conduit 136 and the air inlet tube 140 to the plenum 128 that is carried by the mold arm 114. It is to be understood that the cooling air flow path from the windbox to the plenum 126 that is carried by the mold arm 112 is but an opposite-hand version of that from the windbox for the plenum 128. A hollow member 142 is positioned at the upper end of the conduit 136, and the member 142 has an annular shank portion 142a that extends down into an upper portion of the conduit 136 to permit cooling air to flow from the conduit 136 into the hollow member 142 with very little change in direction of flow for minimal pressure drop. The hollow member 142 is mounted for limited oscillating movement in a horizontal plane relative to the conduit 136, and is provided with an annular, part-spherical bearing surface, 142b that has a horizontally-facing outlet therefrom. The bearing surface 142b has an annular bearing 144 with a part-spherical outer surface mounted therein for pivoting motion of the bearing 144 relative to the hollow member 142 in a vertical plane, the bearing 144 being pinned at 132 to limit its pivoting motion to motion only in a vertical plane. The bearing 144 has an inlet end of the air inlet tube 140 positioned in its inner surface for pivoting motion of the inlet tube 140 with the bearing 144 relative to the bearing 142b. The inlet tube 140 has a separate, part-spherical bearing secured to its outlet and the bearing 150 is received in a part-spherical bearing 128b of the plenum 128 to permit limited pivoting motion of the air inlet tube 140 relative to the plenum 128.

To accommodate changes in length between the bearing 144 and the bearing 150 as a result of the pivoting moton of the arm 114, the air inlet tube 140 has telescoped inner and outer members 140a, 140b, respectively, that slide or plunge relative to one another. The members 140a, 140b are resiliently biased away from one another by a coil spring 152 that is trapped between an underside of the bearing 150 and an outwardly projecting flange 140c on the outer member 140b of the air inlet tube 140.

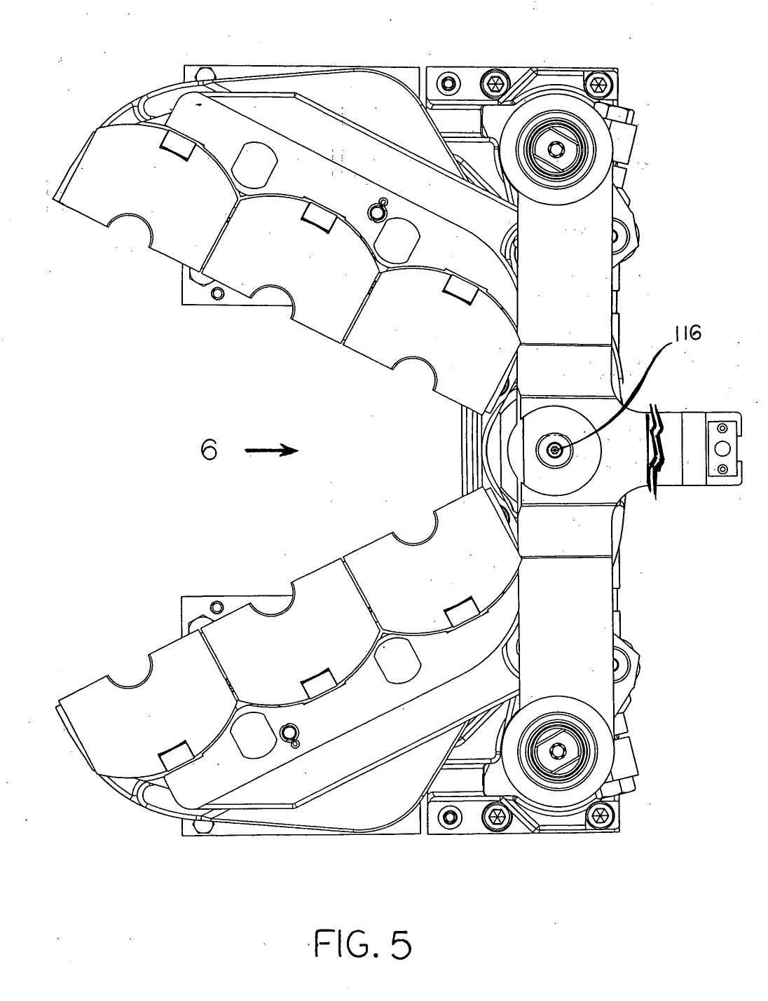

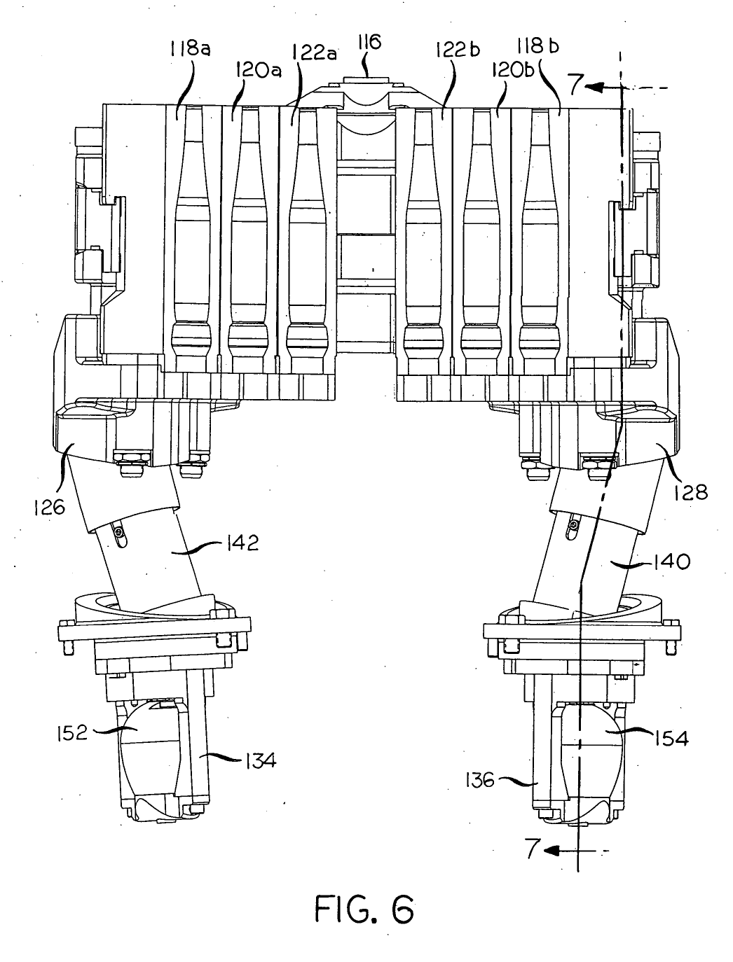

In the system of FIGS. 4-7, the cross-sectional area of the mold cooling air distribution system, in addition to involving very little change in directional flow, remains constant as the mold arms 112, 114, as the case may be, pivot about the shaft 116. Further, the air distribution system of FIGS. 4-7 can be quickly installed by a single person because there is no need for a second person to align telescoping tubes, and the air distribution system is unaffected by drooping of the mold arms 112, 114, which will occur in service as a result of mechanical wear. If desired, the system of FIGS. 4-7 can also be adapted to a blank mold cooling system in place of the system of FIGS. 1-3.

Although the best mode contemplated by the inventors for carrying out the present invention as of the filing date hereof has been shown and described herein, it will be apparent to those skilled in the art that suitable modifications, variations, and equivalents may be made without departing from the scope of the invention, such scope being limited solely by the terms of the following claims and the legal equivalents thereof.

We claim:

1. Apparatus for permitting a fluid to flow from a fixed source to a location that is oscillatible with respect to the fixed source, said apparatus comprising;
an inlet conduit having an inlet end in fluid flow relationship with a fluid outlet of the fixed source, said inlet conduit further having an outlet end;
a hollow member having an inlet portion oscillatible in position in a plane extending transversely to a longitudinal central axis of said inlet conduit in fluid flow communication with said outlet end of said inlet conduit, said hollow member having an outlet portion with a part-spherical bearing surface;
an annular, part-spherical bearing positioned in said part-spherical bearing surface of said hollow member;
a fluid inlet tube in fluid communication with said hollow member, said fluid inlet tube having an inlet end telescopically received in said annular, part-spherical bearing in said hollow member, said fluid inlet tube further having an outlet end with a part-spherical bearing at its outlet end; and
a fluid plenum carried by an oscillating member, said fluid plenum having an inlet with a part-spherical bearing surface, said part-spherical bearing at said outlet end of said fluid inlet tube being received in said part-spherical bearing surface of said fluid plenum, whereby, oscillating motion of said oscillating member causes said annular part-spherical bearing to swivel with respect to said inlet conduit, causes said part-spherical bearing surface of said fluid inlet tube to swivel with respect to said fluid plenum, and causes said inlet end of said fluid inlet tube to move linearly with respect to said part-spherical bearing.

2. Apparatus according to claim 1 wherein:
said fixed source is a supply conduit from a windbox of an I.S. glass container forming machine;
said fluid is cooling air;
said conduit extends vertically; and
said hollow member is a plenum that underlies and oscillates with a mold-carrying arm of the I.S. machine.

3. Apparatus according to claim 2 wherein:
said inlet portion of said hollow member is telescopically received in said outlet end of said conduit.

4. Apparatus according to claim 3 wherein:
said fluid inlet tube has a uniform wall thickness from an inlet end of said fluid inlet tube to said part-spherical bearing at said outlet end of said fluid inlet tube.

5. Apparatus according to claim 1 wherein:
said outlet portion of said hollow member extends at a substantial angle to said inlet portion of said hollow member.

6. Apparatus according to claim 5 wherein:
said substantial angle is substantially equal to 90°.

7. Apparatus according to claim 1 wherein said inlet conduit has a vertically extending longitudinal central axis, and wherein said annular part-spherical bearing is pinned with respect to said part-spherical bearing surface of said hollow member for pivoting motion only in a vertical plane.

8. Apparatus according to claim 1 and further comprising:
an externally controllable valve in said inlet conduit for controlling the rate of fluid flow through said apparatus.

9. Apparatus according to claim 1 wherein:
said hollow member involves no substantial variation in fluid flow path direction therethrough.

10. Apparatus according to claim 9 wherein:
there is no substantial variation in the angle of fluid flow direction from said hollow member through said inlet conduit.

11. Apparatus according to claim 10 wherein said conduit comprises:
an outer member; and
inner member telescopically mounted in said outer member;
and further comprising means for resiliently biasing said inner member and said outer member from one another.

12. A method for permitting a fluid to flow from a fixed source to a location that is oscillatible with respect to the source, the method comprising:
providing a fixed source of a fluid, the fixed source having a fluid outlet;
providing a conduit having an inlet in fluid relationship with the fluid outlet of the fixed source, the conduit further having an outlet;
providing a hollow member having an inlet in fluid communication with the outlet of the conduit, the hollow member having a fluid outlet, said hollow member being oscillatible with the conduit in a plane that extends transversely of an axis of flow through the conduit;
providing a plenum at the location, the plenum having an inlet;
providing a fluid inlet tube extending between the hollow member and the plenum, the inlet tube having an inlet end in fluid communication with the hollow member and an outlet end in fluid communication with the plenum;
connecting one of the inlet end of the fluid inlet tube and the outlet end of the fluid inlet tube to the hollow member by way of a first, part-spherical bearing, connecting the other of the inlet end of the fluid inlet tube and the outlet end of the fluid inlet tube to the plenum by way of a second, part-spherical bearing; and
providing for telescopic or plunging motion between one of said inlet end of said fluid inlet tube and said first, part-spherical bearing, said outlet end of said fluid inlet tube and said second, part-spherical bearing, and within said fluid inlet tube to accommodate changes in distance between said source and said location.

13. The method according to claim 12 wherein:
the fixed source is a windbox of an I.S. glass container forming machine;
the fluid is cooling air;
the conduit extends vertically; and
the hollow member is a plenum that underlies and oscillates with a mold-carrying arm of a glass container forming machine of the I.S. type.

14. The method according to claim 13 wherein the telescopic motion is provided between the fluid inlet tube and one of said first part-spherical and second part-spherical bearing and exists between an inlet end of the fluid inlet tube and one of the first part-spherical bearing and the second part spherical bearing.

15. The method according to claim 14 wherein said first part-spherical bearing is located at the fluid inlet end of the fluid inlet tube.

16. The method according to claim 13 wherein:
the fluid inlet tube has a uniform wall thickness from its inlet end to its part-spherical bearing.

17. The method according to claim 13 wherein;
the fluid inlet tube has an outer element and an inner element telescopically positioned within the outer element;
the telescopic motion is provided by resiliently biasing the outer element and the inner element away from one another;
said hollow member involves no substantial variation in fluid flow path direction therethrough; and
there is no substantial variation in the angle of fluid flow direction from the hollow member through the inlet conduit.

18. The method according to claim 12 wherein:
the outlet portion of said hollow member extends at a substantial angle to said inlet portion of said inlet member.

19. The method according to claim 18 wherein the substantial angle is approximately 90°.

20. The method according to claim 19 wherein the mold-carrying arm is an arm that carries parison-forming molds for forming parisons from gobs of glass at a formable temperature.

21. The method according to claim 17 wherein the mold-carrying arm is an arm that carries blow molds for blowing containers from parisons of glass at a formable temperature.
